(19) United States
(12) Patent Application Publication
(10) Pub. No.: US 2014/0292689 A1
(43) Pub. Date: Oct. 2, 2014

(54) INPUT DEVICE, INPUT METHOD, AND RECORDING MEDIUM

(71) Applicant: Sony Corporation, Tokyo (JP)

(72) Inventors: YUHEI AKATSUKA, Nagano (JP); IKUO YAMANO, Tokyo (JP); KUNIHITO SAWAI, Kanagawa (JP)

(73) Assignee: Sony Corporation, Tokyo (JP)

(21) Appl. No.: 14/219,516

(22) Filed: Mar. 19, 2014

(30) Foreign Application Priority Data
Mar. 27, 2013 (JP) 2013-066002

(51) Int. Cl. G06F 3/041

(52) U.S. Cl. CPC G06F 3/0412
USPC 345/173

(57) ABSTRACT

There is provided an input device including an input face including a plurality of input regions having different touch feelings, a detection unit configured to detect an operation of an operating body in the plurality of input regions, and an assignment unit configured to assign different output values according to operations of the operating body in each of the input regions based on detection results of the detection unit.

### CROSS REFERENCE TO RELATED APPLICATIONS

This application claims the benefit of Japanese Priority Patent Application JP 2013-066002 filed Mar. 27, 2013, the entire contents of which are incorporated herein by reference.

### BACKGROUND

The present disclosure relates to an input device, an input method, and a recording medium.

As input devices of a computer, a mouse and a touch pad, which are pointing devices, have become widespread to enable users (operators) to perform simple operations. Thus, the operators perform various operations on a display screen of a computer using such input devices.

JP 2000-330716A discloses a technology in which a touch pad is divided into a plurality of regions and processes (for example, closing, maximizing, and minimizing of windows) are executed according to the regions that a user presses.

### SUMMARY

However, there are cases in which an operator performs an input operation with an input device placed out of a range of his or her vision. Such an operation performed by the operator out of a range of his or her vision is likely to result in an erroneous operation. JP 2000-330716A also assumes that an operator operates a touch pad while viewing the touch pad, and there is concern that, when the touch pad is positioned out of a range of his or her vision, the operator will have difficulty identifying regions of the touch pad and thus will not be able to perform an intended operation.

Thus, the present disclosure proposes an input device that enables an operator to perform an intended input even when the input device is placed out of a range of his or her vision.

According to an embodiment of the present disclosure, there is provided an input device including an input face including a plurality of input regions having different touch feelings, a detection unit configured to detect an operation of an operating body in the plurality of input regions, and an assignment unit configured to assign different output values according to operations of the operating body in each of the input regions based on detection results of the detection unit.

According to an embodiment of the present disclosure, there is provided an input method including detecting an operation of an operating body in a plurality of input regions on an input face including the plurality of input regions having different touch feelings, and assigning different output values according to operations of the operating body in each of the input regions based on detection results.

According to an embodiment of the present disclosure, there is provided a non-transitory computer-readable recording medium having a program recorded thereon, the program causing a computer to execute: detecting an operation of an operating body in a plurality of input regions on an input face configured to include the plurality of input regions having different touch feelings, and assigning different output values according to operations of the operating body in each of the input regions based on detection results.

According to an embodiment of the present disclosure described above, an operator can perform an intended input even when an input device is placed out of a range of his or her vision.

### BRIEF DESCRIPTION OF THE DRAWINGS

FIG. 1 is a perspective diagram illustrating an example of an exterior configuration of a touch input device 100 according to an embodiment of the present disclosure;

FIG. 2 is an exploded perspective diagram of the touch input device 100 illustrated in FIG. 1;

FIG. 3 is a block diagram showing an example of a functional configuration of the touch input device 100;

FIG. 4 is a diagram illustrating an example of a display screen 220 of a display unit 208;

FIG. 5 is a diagram for describing Assignment Example 1 of an output value according to a touch operation on a touch input face 110a;

FIG. 6 is a diagram for describing Assignment Example 2 of an output value according to a touch operation;

FIG. 7 is a diagram for describing Assignment Example 3 of an output value according to a touch operation;

FIG. 8 is a diagram for describing Assignment Example 4 of an output value according to a touch operation;

FIG. 9 is a diagram for describing Assignment Example 5 and Assignment Example 6 of output values according to touch operations;

FIG. 10 is a diagram for describing Assignment Example 7 and Assignment Example 8 of output values according to touch operations;

FIG. 11 is a diagram for describing Assignment Example 9 and Assignment Example 10 of output values according to touch operations;

FIG. 12 is a diagram for describing Assignment Example 11 of an output value according to a touch operation;

FIG. 13 is a diagram for describing Assignment Example 12 of an output value according to a touch operation;

FIG. 14 is a diagram for describing Assignment Example 13 of an output value according to a touch operation;

FIG. 15 is a diagram for describing Assignment Example 14 of an output value according to a touch operation;

FIG. 16 is a diagram for describing Assignment Example 15 of an output value according to a touch operation;

FIG. 17 is a diagram for describing Assignment Example 16 of an output value according to a touch operation;

FIG. 18 is a diagram for describing Assignment Example 17 of an output value according to a touch operation;

FIG. 19 is a diagram for describing Assignment Example 18 of an output value according to a touch operation;

FIG. 20 is a diagram for describing Assignment Example 19 and Assignment Example 20 of output values according to touch operations;

FIG. 21 is a diagram for describing Assignment Example 21 of an output value according to a touch operation;

FIG. 22 is a diagram for describing Assignment Example 22 of an output value according to a touch operation;

FIG. 23 is a perspective diagram illustrating a first modified example of an exterior configuration of the touch input device 100;

FIG. 24 is a perspective diagram illustrating a second modified example of the exterior configuration of the touch input device 100; and

FIG. 25 is a diagram for describing another use form of the touch input device 100.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Note that description will be provided in the following order.

1. Configuration of an input device
1-1. Overview of a configuration of an input device
1-2. Functional configuration of an input device

2. Assignment examples of output values of touch operations

3. Other embodiments

4. Conclusion

<1. Configuration of an Input Device>

(1-1. Overview of a Configuration of an Input Device)

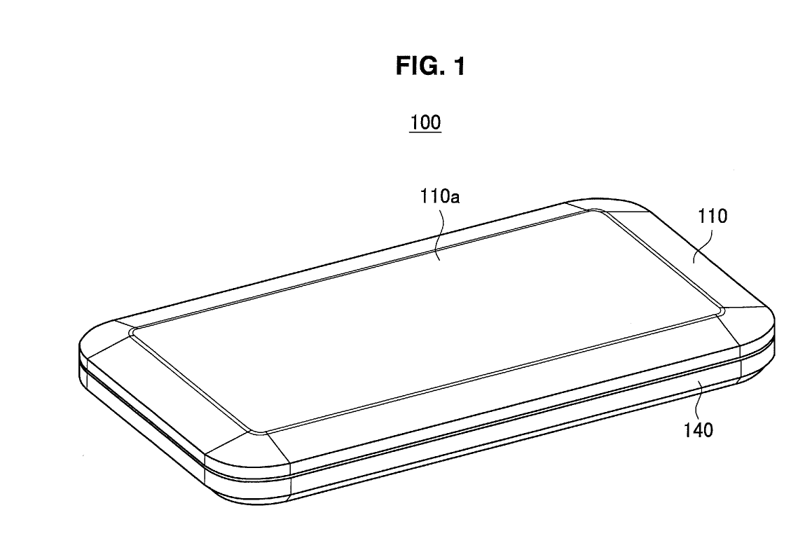

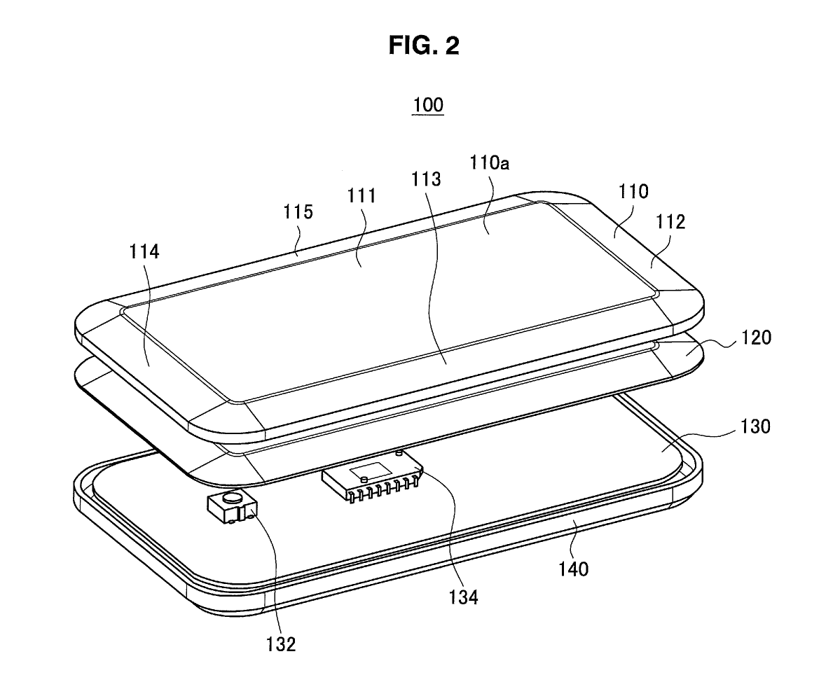

An overview of a configuration example of a touch input device 100 that is an example of an input device according to an embodiment of the present disclosure will be described with reference to FIGS. 1 and 2. FIG. 1 is a perspective diagram illustrating an example of an exterior configuration of the touch input device 100 according to an embodiment of the present disclosure. FIG. 2 is an exploded perspective diagram of the touch input device 100 illustrated in FIG. 1

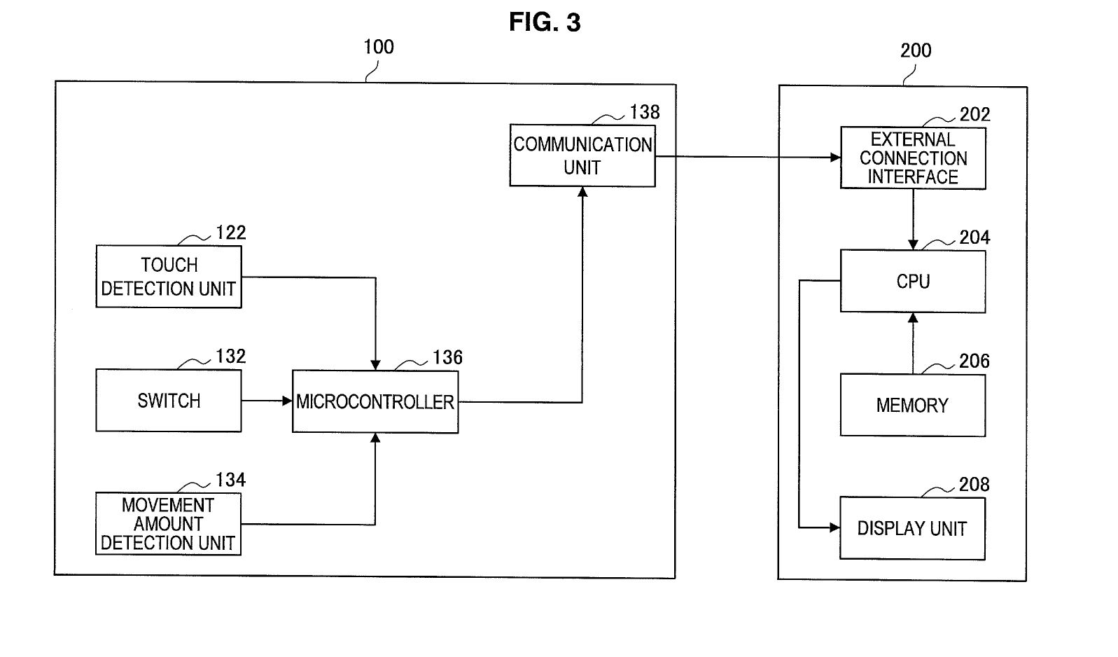

The touch input device 100 is a touch input device with which a user who is an operator can perform input. Using the touch input device 100, the user can operate a computer 200 (see FIG. 3) connected to the touch input device 100. The touch input device 100 is used as, for example, a mouse that is a pointing device.

The touch input device 100 has a rectangular shape as illustrated in FIG. 1. The touch input device 100 has an upper case 110, a touch detection substrate 120, a controller substrate 130, and a lower case 140, as shown in FIG. 2.

The upper case 110 constitutes a housing of the touch input device 100 with the lower case 140. The upper case 110 has a touch input face 110a on a surface side on which a user can perform touch operations using his or her finger that is an operating body. The touch input face 110a according to the present embodiment includes a plurality of input regions having different touch feelings.

Here, different touch feelings are touch feelings in which the user can perceive a position on the touch input face 110a and an orientation thereof without moving his or her finger. Accordingly, even when the touch input device 100 is placed out of a range of the user's vision, the user can perceive a position on the touch input face 110a and an orientation thereof from the plurality of input regions having different touch feelings, and thus an intended operation can be performed.

In addition, the touch input face 110a forms the plurality of input regions having the different touch feelings as an angle of the surface is changed. To be specific, the touch input face 110a includes a flat face 111 positioned at the center of the upper case 110, and inclined faces 112, 113, 114, and 115 formed to be inclined around the flat face 111 as shown in FIG. 2. The flat face 111 and the inclined faces 112, 113, 114, and 115 are the plurality of input regions having different touch feelings.

The flat face 111 is a flat and smooth face forming a top face of the upper case 110. The inclined faces 112, 113, 114, and 115 are inclined faces which are inclined from the flat face 111 toward the circumferential edge of the upper case 110 having a predetermined inclination angle and surround the flat face 111. The four inclined faces 112, 113, 114, and 115 may have the same inclination angle or different inclination angles.

Note that, on the surface of the touch input face 110a, concave and convex shapes may be formed. In addition, on the surface of the touch input face 110a, differences of hardness may be made. Thereby, the user easily perceives the different touch feelings. Furthermore, on the surface of the touch input face 110a, printing may be performed.

The touch detection substrate 120 is a circuit board that can detect touch operations (for example, contact of a finger) of the user on the flat face 111 and the inclined faces 112, 113, 114, and 115. The touch detection substrate 120 faces the rear face of the upper case 110, and is formed following the shape of the touch input face 110a.

The controller substrate 130 is a circuit board having a control unit that controls the touch input device 100. The controller substrate 130 is provided between the touch detection substrate 120 and the lower case 140.

The lower case 140 has the same shape as the upper case 110. A gap is formed between the upper case 110 and the lower case 140, and the touch detection substrate 120 and the controller substrate 130 are disposed in the gap.

(1-2. Functional Configuration of an Input Device)

An example of a functional configuration of the touch input device 100 will be described with reference to FIG. 3. FIG. 3 is a block diagram showing an example of the functional configuration of the touch input device 100. As shown in FIG. 3, the touch input device 100 has a touch detection unit 122, a switch 132, a movement amount detection unit 134, a microcontroller 136, and a communication unit 138.

The touch detection unit 122 is provided on the touch detection substrate 120. The touch detection unit 122 has a function of a detection unit that detects operations of a finger in the plurality of regions of the touch input face 110a. To be specific, the touch detection unit 122 detects touch operations of a finger of a user on the flat face 111 and the inclined faces 112, 113, 114, and 115 of the upper case 110. The touch detection unit 122 detects positions that come into contact with the finger of the user and then outputs the detection as contact information to the microcontroller 136.

The switch 132 is provided on the controller substrate 130 as illustrated in FIG. 2. When the user presses a portion of the upper case 110 that corresponds to the switch 132, an input by the switch 132 can be made.

The movement amount detection unit 134 is provided on the controller substrate 130 as illustrated in FIG. 2. The movement amount detection unit 134 has a function of detecting movement amounts of the touch input device 100 when the user moves the touch input device 100 that is a mouse. The movement amount detection unit 134 outputs the detected movement amounts to the microcontroller 136.

The microcontroller 136 is a control unit that controls the touch input device 100, and is provided on the controller substrate 130. The microcontroller 136 according to the present embodiment functions as an assignment unit that assigns different output values of touch operations of a finger in the plurality of input regions (the flat face 111 and the inclined faces 112, 113, 114, and 115) of the touch input face 110a based on detection results of the touch detection unit 122.

To be specific, the microcontroller 136 assigns, based on the contact information from the touch detection unit 122, output values of contact duration, movement amounts, movement speeds, and movement directions of a finger of the user, the number and the positions of the finger that is in contact or moving, and the like with respect to the flat face 111 and the inclined faces 112, 113, 114, and 115. The microcontroller 136 outputs information of the output values corresponding to touch inputs to the communication unit 138.

In addition, the microcontroller 136 assigns different output values according to operations of a finger between the plurality of input regions. For example, the microcontroller 136 assigns an output value of a tracing operation of a finger from the inclined face 112 to the inclined face 113. Accordingly, variations of an operation using the plurality of inclined faces 112, 113, 114, and 115 can increase.

In addition, the microcontroller 136 assigns different output values according to operation positions of a finger in an input region. For example, the microcontroller 136 assigns different output values according to locations of the inclined face 115 in which clicking is performed. Accordingly, a plurality of operations can be performed using one input region.

In addition, the microcontroller 136 assigns output values of operations of a plurality of fingers in the plurality of input regions. For example, when the inclined face 113 and the inclined face 115 are traced with two fingers, a specific output value is assigned. When such an operation using a plurality of fingers is considered, variations of an operation can further increase than when an operation is made with one finger.

The communication unit 138 transmits such output values of touch inputs received from the microcontroller 136 to the computer 200 connected to the touch input device 100. The communication unit 138 transmits information of the output values in a wired or wireless manner.

Herein, a configuration example of the computer 200 with which the touch input device 100 can communicate will be described with reference to FIG. 3. The computer 200 has an external connection interface 202, a CPU 204, a memory 206, and a display unit 208 that is an example of a display device.

The external connection interface 202 receives information of output values of touch inputs from the communication unit 138 of the touch input device 100. The CPU 204 performs processes of programs stored in the memory 206 based on the information of the output values received from the external connection interface 202. For example, the CPU 204 performs control of a display screen of the display unit 208 and the like based on the information of the output values.

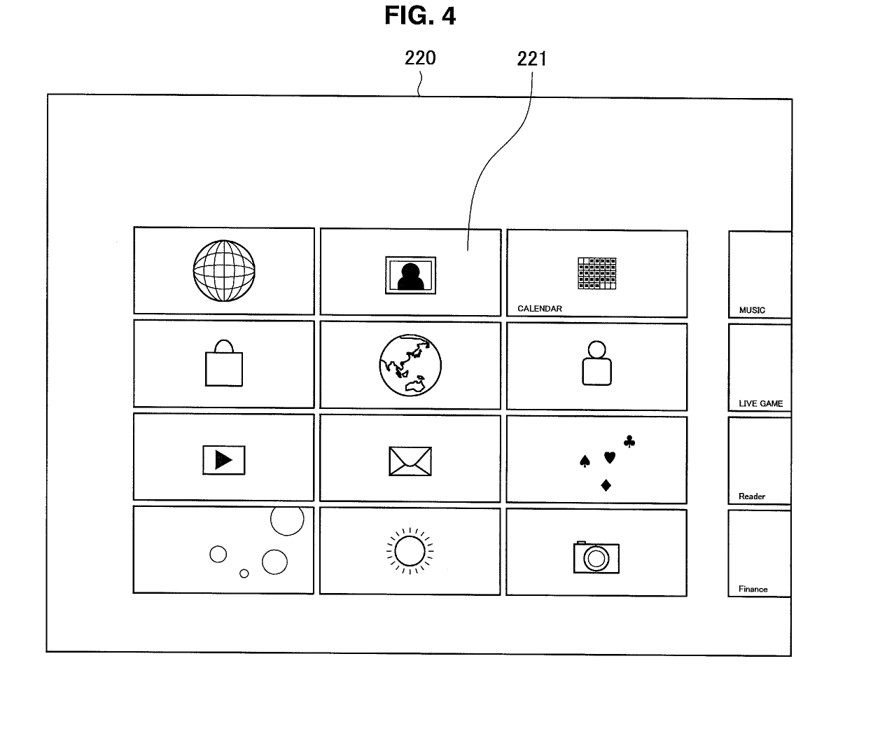

FIG. 4 is a diagram illustrating an example of the display screen 220 of the display unit 208. On the display screen 220 shown in FIG. 4, a plurality of objects are arrayed in a regular order. Here, when the display unit 208 is a touch panel, the user can touch and select an object 221 displayed on the display screen 220. Note that, in the present embodiment, because the display unit 208 is not a touch panel, a display state is assumed to be transitioned by the user performing a touch input using the touch input device 100 and thereby selecting the object 221 on the display screen 220 or the like.

The microcontroller 136 described above assigns an output value of an operation performed on the display screen 220 of the display unit 208 as an output value. Accordingly, the user can perform operations on the display screen 220 by performing touch operations of the touch input device 100 positioned out of a range of his or her vision while viewing the display screen 220.

In addition, the microcontroller 136 assigns an output value so that an operation performed on the display screen 220 corresponds to a touch operation in an input region of the touch input face 110a. Accordingly, the touch operation of the touch input device 100 is associated with the operation performed on the display screen 220, and even though the display unit 208 is not a touch panel, an operation can be performed with a natural feeling of operating a touch panel.

<2. Assignment Examples of Output Values of Touch Operations>

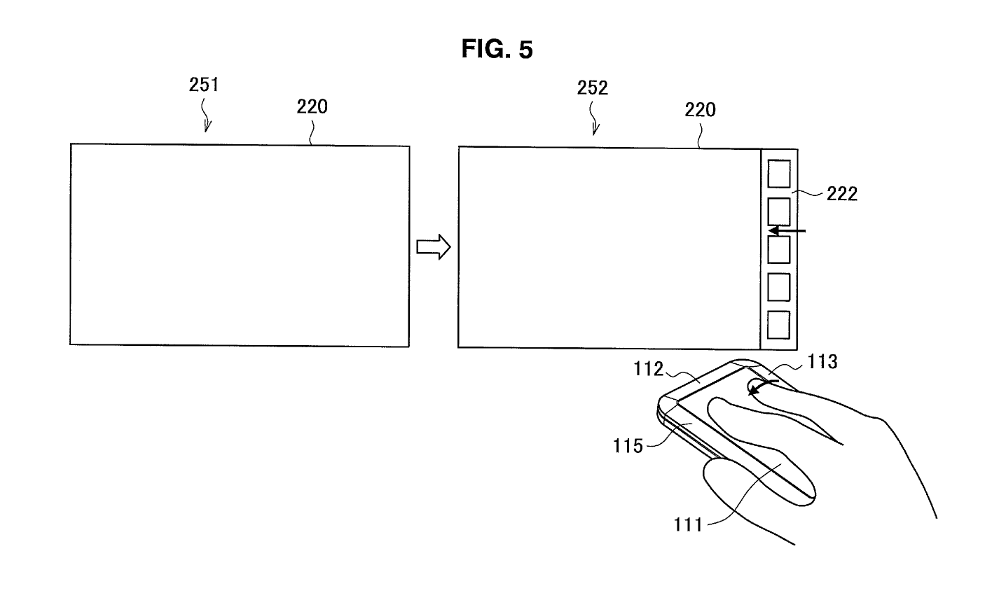

Assignment examples of output values of touch operations on the touch input face 110a will be described with reference to FIGS. 5 to 22. Hereinbelow, the relationship between an assigned output value and a process of the display screen 220 will also be described.

FIG. 5 is a diagram for describing Assignment Example 1 of an output value according to a touch operation on the touch input face 110a. In Assignment Example 1, it is assumed that a user performs a touch operation using the touch input device 100 when the display screen 220 of the display unit 208 of the computer 200 is in a display state 251 shown in FIG. 5. To be specific, the user moves his or her finger from the inclined face 113 on the right side of the touch input device 100 to the flat face 111. When the touch detection unit 122 detects this touch operation, the microcontroller 136 assigns an output value of the touch operation (herein, an output value that calls out a right menu of the display screen 220). When the output value is received, the computer 200 transitions the display screen 220 from the display state 251 to a display state 252 in which the right menu 222 is displayed.

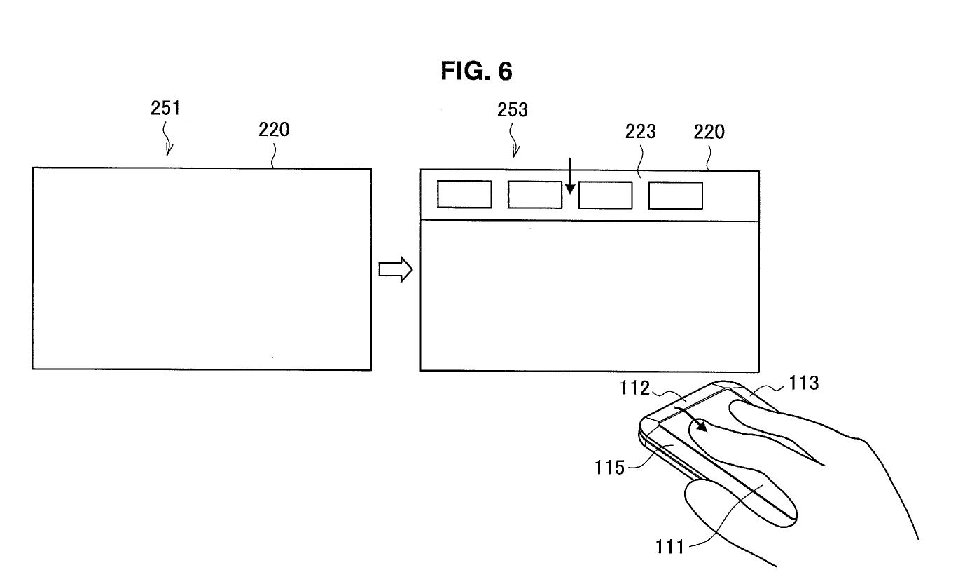

FIG. 6 is a diagram for describing Assignment Example 2 of an output value according to a touch operation on the touch input face 110a. In Assignment Example 2, it is assumed that, when the display screen 220 is in the display state 251, the user moves his or her finger from the inclined face 112 on the upper side of the touch input device to the flat face 111 as a touch operation. When this touch operation is detected, the microcontroller 136 assigns an output value that calls out an upper menu of the display screen 220. When the output value is received, the computer 200 transitions the display screen 220 from the display state 251 to a display state 253 in which the upper menu 223 is displayed.

In Assignment Examples 1 and 2 described above, when the finger is moved from the inclined face 113 (or the inclined face 112) to the flat face 111, the user can perceive a change in the touch feeling. At the same time, the display state of the display screen 220 is changed. In other words, the change in the touch feeling coincides with the display timing of the display screen 220. In addition, since the operation directions of the touch operations coincide with the directions in which the menus (the right menu 222 and the upper menu 223) of the display screen 220 are displayed, a natural feeling like operating a touch panel is further intensified.

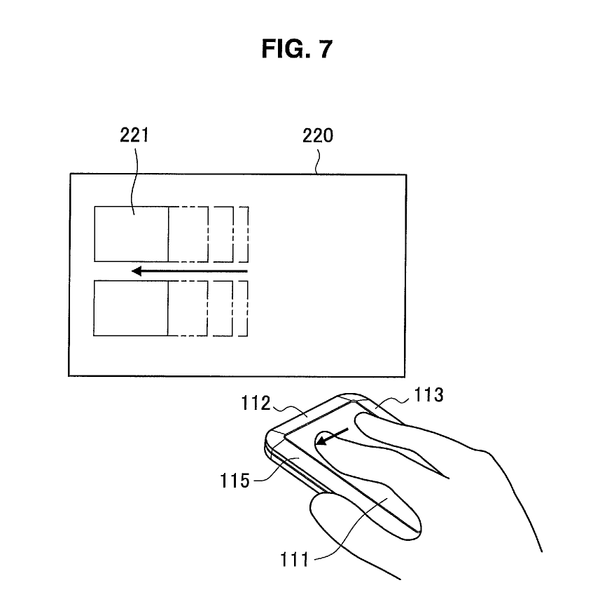

FIG. 7 is a diagram for describing Assignment Example 3 of an output value according to a touch operation on the touch input face 110a. In Assignment Example 3, it is assumed that, when the display screen 220 is in a display state in which an object is displayed at the center, the user moves his or her finger from the right side to the left side on the flat face 111 as a touch operation. When this touch operation is detected, the microcontroller 136 assigns an output value for scrolling the display screen 220 in the left direction. When the output value is received, the computer 200 transitions the display screen 220 to a display state in which the screen is scrolled in the left direction.

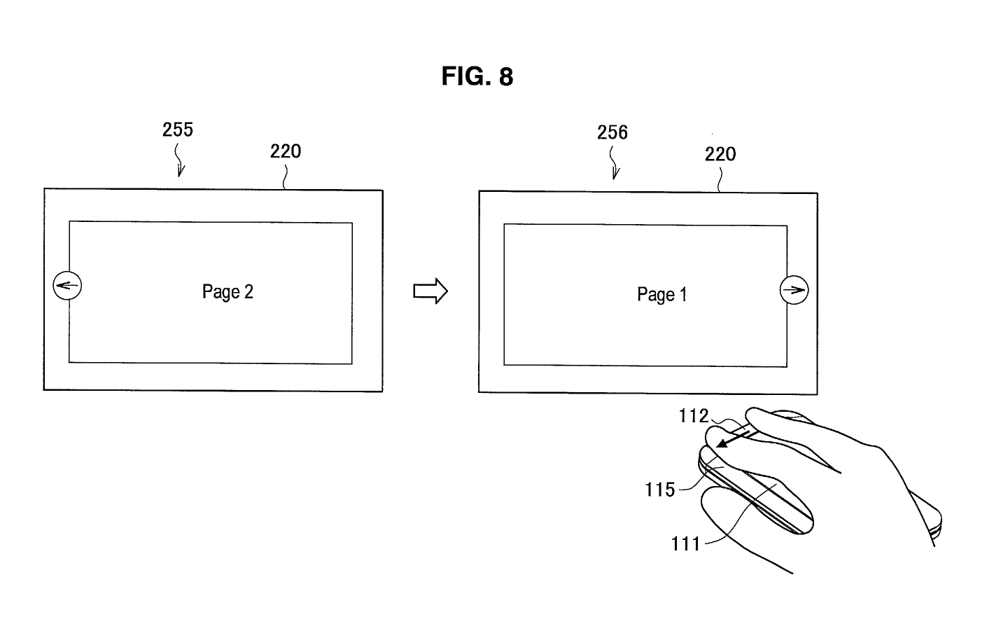

FIG. 8 is a diagram for describing Assignment Example 4 of an output value according to a touch operation on the touch input face 110a. In Assignment Example 4, it is assumed that, when the display screen 220 is in a display state 255 in which Page 2 is displayed, the user moves his or her finger on the inclined face 112 on the upper side of the touch input device from the right side to the left side thereof as a touch operation. When this touch operation is detected, the microcontroller 136 assigns an output value for performing scrolling on the display screen 220 in the left direction (returning to Page 1 previously displayed). When the output value is received, the computer 200 transitions the display screen 220 from the display state 255 to a display state 256 for returning to and displaying Page 1.

In Assignment Examples 3 and 4 described above, even though the operation directions on the touch input face 110a are the same, when faces on which touch operations are performed are different (the flat face 111 and the inclined face 112), the assigned output values are different, and thus variations of operations can increase. Note that, since the operation directions on the touch input face 110a coincide with the directions in which the displays on the display screen 220 are switched, the natural feeling is maintained.

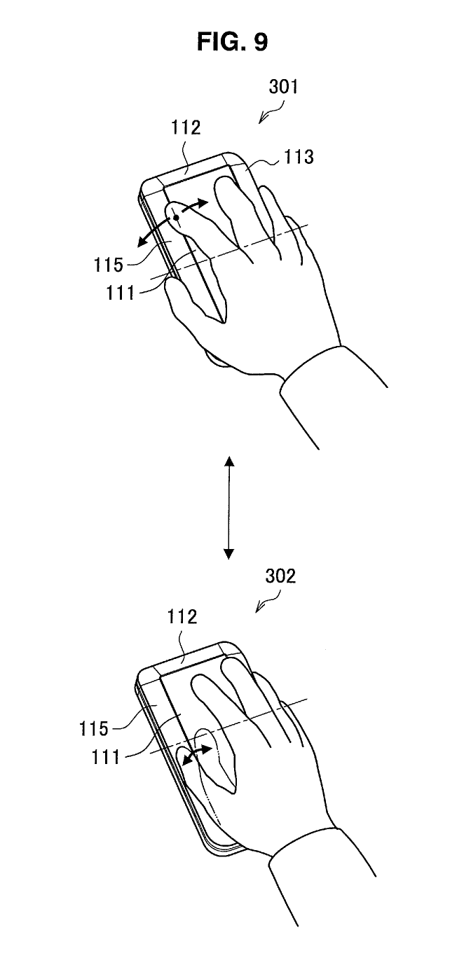

FIG. 9 is a diagram for describing Assignment Example 5 and Assignment Example 6 of output values according to touch operations. In Assignment Examples 5 and 6, output values are different according to locations in which fingers cross over left edges between the inclined face 115 on the left side and the flat face 111 as touch operations.

To be specific, in Assignment Example 5, the index finger crosses over an upper part of the left edge as shown in an operation state 301. Then, the microcontroller 136 assigns an output value for switching an application to be activated on the display screen 220. On the other hand, in Assignment Example 6, the thumb crosses over a lower part of the left edge as shown in an operation state 302. Then, the microcontroller 136 assigns an output value for turning and returning pages displayed on the display screen 220. As described above, since different operations can be performed with respect to the display screen 220 using the index finger and the thumb, variation of operations can increase.

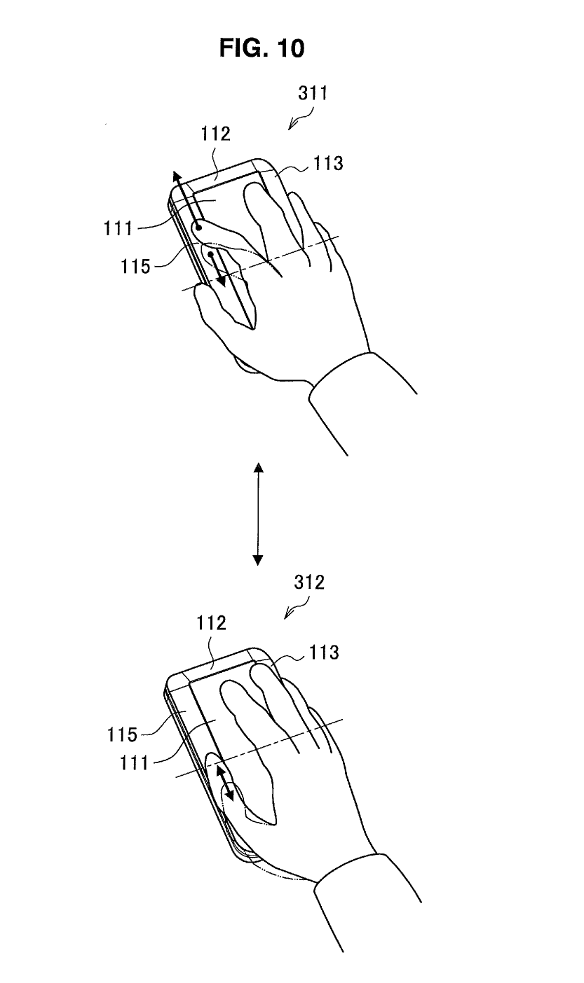

FIG. 10 is a diagram for describing Assignment Example 7 and Assignment Example 8 of output values according to touch operations. In Assignment Examples 7 and 8, output values are different according to locations which a finger traces on the inclined face 115 on the left side as touch operations.

To be specific, in Assignment Example 7, the index finger traces an upper part of the inclined face 115 in an edge direction as shown in an operation state 311. Then, the microcontroller 136 assigns an output value for dividing the screen of the display screen 220. On the other hand, in Assignment Example 8, the thumb traces a lower part of the inclined face 115 in the edge direction as shown in an operation state 312. Then, the microcontroller 136 assigns an output value for enlarging and reducing the screen of the display screen 220. In this manner, since different operations can be performed with respect to the display screen 220 using the index finger and the thumb, variations of operations can increase.

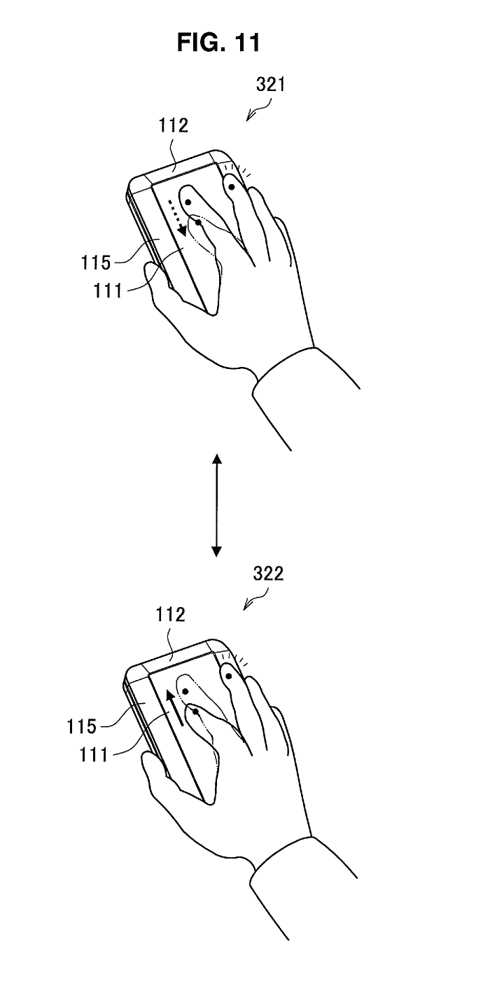

FIG. 11 is a diagram for describing Assignment Example 9 and Assignment Example 10 of output values according to touch operations. In Assignment Examples 9 and 10, output values are different according to directions in which, in the state in which a first finger (middle finger) is brought into contact with the inclined face 113 on the right side, a second finger (index finger) traces the flat face 111.

To be specific, in Assignment Example 9, in the state in which the middle finger comes into contact with the inclined face 113 as shown in an operation state 321, the index finger downwardly traces the flat face 111. Then, the microcontroller 136 assigns an output value corresponding to the downward arrow (↓) key operation on the display screen 220. On the other hand, in Assignment Example 10, in the state in which the middle finger comes into contact with the inclined face 113 as shown in an operation state 322, the index finger upwardly traces the flat face 111. Then, the microcontroller 136 assigns an output value corresponding to the upward arrow (↑) key on the display screen 220. By using two fingers in this manner, variations of operations can further increase than when an operation is performed with one finger.

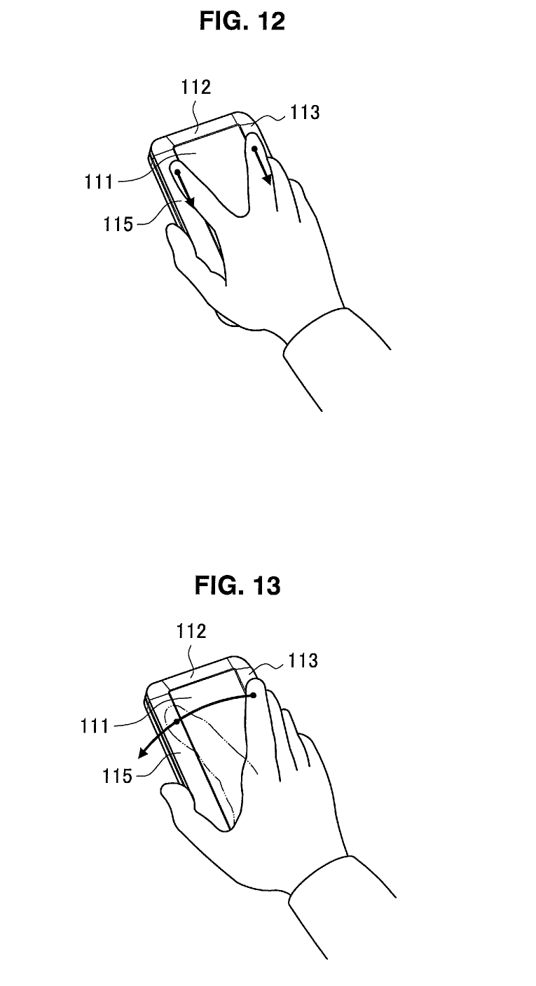

FIG. 12 is a diagram for describing Assignment Example 11 of an output value according to a touch operation on the touch input face 110a. In Assignment Example 11, the user traces two inclined faces with two fingers at the same time as a touch operation. To be specific, when the index finger downwardly traces the inclined face 115 in the edge direction, the middle finger downwardly traces the inclined face 113 in the edge direction. Then, the microcontroller 136 assigns an output value for shifting to a standby mode of the display screen 220. Since the action of the two fingers tracing the two inclined faces at the same time as described above is hard to perform as a touch operation, the action is assigned for the standby mode of which input frequency is low.

FIG. 13 is a diagram for describing Assignment Example 12 of an output value according to a touch operation on the touch input face 110a. In Assignment Example 12, the user causes one finger to trace two inclined faces as a touch operation. To be specific, the index finger traces from the inclined face 113 to the inclined face 115. Then, the microcontroller 136 assigns an output value for displaying a search menu on the display screen 220. By assigning the output value for the touch operation using a plurality of inclined faces, variations of operations can further increase.

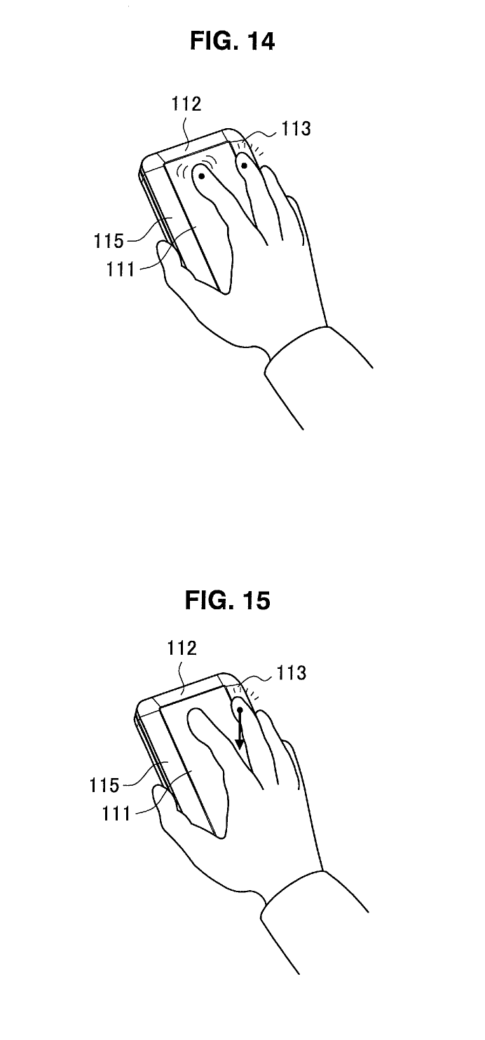

FIG. 14 is a diagram for describing Assignment Example 13 of an output value according to a touch operation on the touch input face 110a. In Assignment Example 13, in the state in which the middle finger is placed on the inclined face 113, the user taps the flat face 111 with the index finger. Then, the microcontroller 136 assigns an output value for increasing the volume of sound. Note that, for the sake of a symmetric structure, the microcontroller 136 may assign an output value for lowering the volume of sound when a finger is placed on the inclined face 115 and another finger taps the flat face 111. When such a tap operation is considered, variations of operations can further increase.

FIG. 15 is a diagram for describing Assignment Example 14 of an output value according to a touch operation on the touch input face 110a. In Assignment Example 14, the user places his or her middle finger on the inclined face 113 and performs clicking with the middle finger in that state. Then, the microcontroller 136 assigns an output value corresponding to a “Home” key operation. Note that, when clicking is performed using another finger placed on the flat face 111, the microcontroller 136 may assign an output value corresponding to a right or left clicking operation of a mouse. When such a clicking operation is considered, variations of operations can further increase.

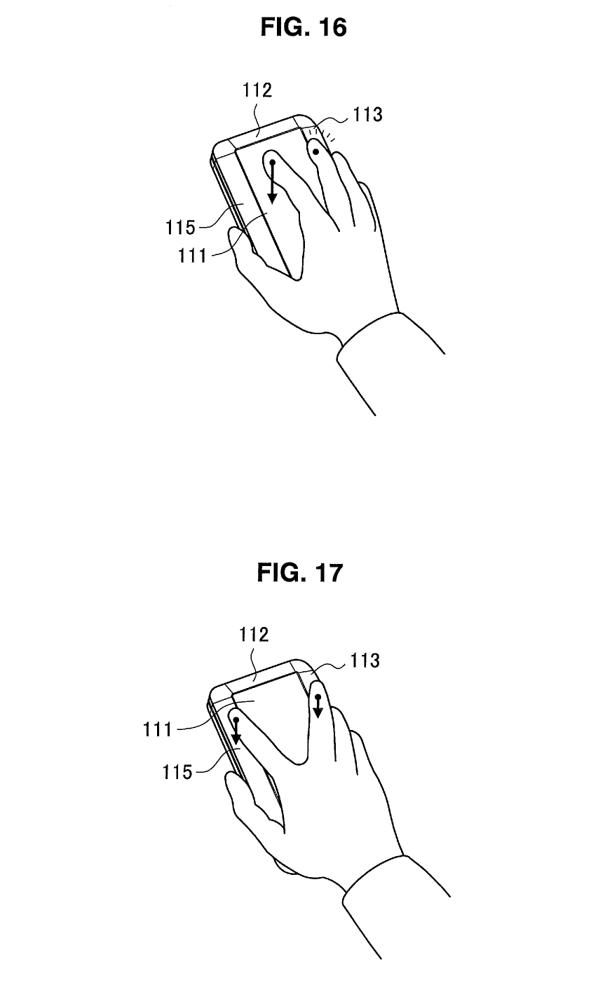

FIG. 16 is a diagram for describing Assignment Example 15 of an output value according to a touch operation on the touch input face 110a. In Assignment Example 15, the user performs clicking on the flat face 111 with the index finger in the state in which the middle finger is placed on the inclined face 113. Then, the microcontroller 136 assigns an output value corresponding to an “Enter” key operation. When such a clicking operation is considered, variations of operations can further increase.

FIG. 17 is a diagram for describing Assignment Example 16 of an output value according to a touch operation on the touch input face 110a. In Assignment Example 16, the user performs clicking with his or her middle finger and index finger in the state in which the fingers (middle finger and index finger) are respectively placed on the inclined face 113 and the inclined face 115. Then, the microcontroller 136 assigns an output value corresponding to a “Delete” key operation (for example, an operation of removing an object displayed on the display screen 220). When such a clicking operation is considered, variations of operations can further increase.

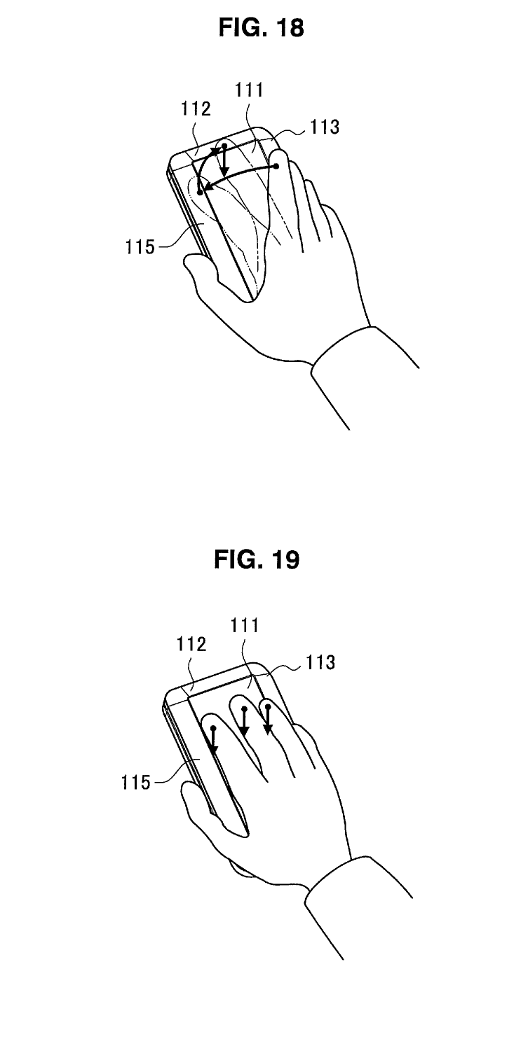

FIG. 18 is a diagram for describing Assignment Example 17 of an output value according to a touch operation on the touch input face 110a. In Assignment Example 17, the user traces from the inclined face 113 to the inclined face 115 with his or her index finger, and then clicks the inclined face 112. Then, the microcontroller 136 detects a series of touch operations and then assigns an output value for releasing lock (password unlock) of the screen of the display screen 220. The user can memorize the series of touch operations to use as an encrypted operation.

In the above, Assignment Examples of the output values corresponding to the touch operations in which the inclined faces 112, 113, 114, and 115 are used have been described. Hereinbelow, Assignment Examples 18 to 21 of output values corresponding to touch operations in which the flat face (a surface of the pad) 111 is used without using the inclined faces 112, 113, 114, and 115 will be described with reference to FIGS. 19 to 22.

FIG. 19 is a diagram for describing Assignment Example 18 of an output value according to a touch operation on the touch input face 110a. In Assignment Example 18, the user performs clicking in the state in which three of his or her fingers are placed on the flat face 111. Then, the microcontroller 136 assigns an output value for closing an active window on the display screen 220. Since clicking the flat face 111 with three fingers is not generally performed, the operation is effective when a specific input is made.

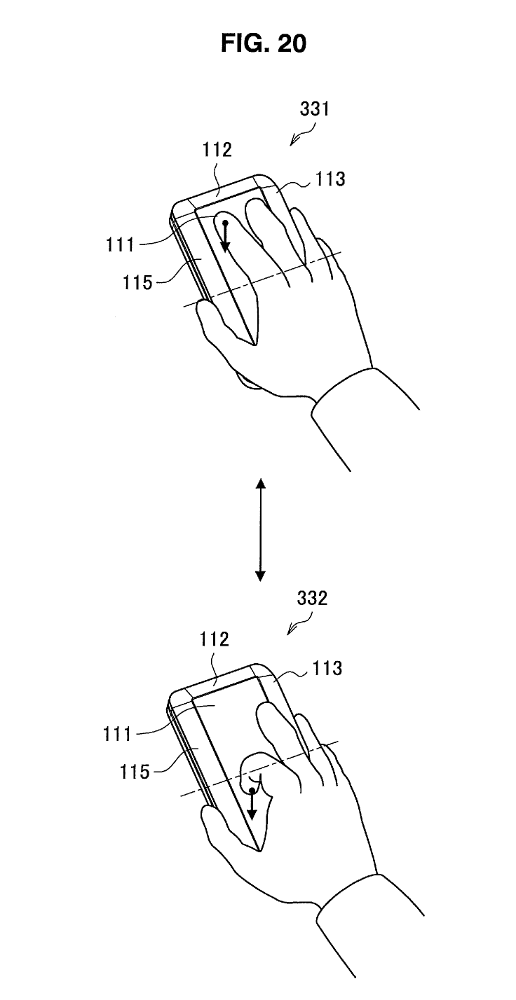

FIG. 20 is a diagram for describing Assignment Example 19 and Assignment Example 20 of output values according to touch operations. In Assignment Examples 19 and 20, the output values are different according to locations of the flat face 111 in which clicking is performed as a touch operation.

To be specific, in Assignment Example 19, clicking is performed on an upper portion of the flat face 111 with the index finger as shown in an operation state 331. Then, the microcontroller 136 assigns an output value corresponding to left-clicking of a mouse. On the other hand, in Assignment Example 20, clicking is performed on a lower portion of the flat face 111 with the index finger as shown in an operation state 332. Then, the microcontroller 136 assigns an output value corresponding to right-clicking of a mouse. In general, left-clicking of a mouse is more frequently performed than right-clicking Thus, as the fingertip is placed in the lower portion of the flat face 111 in which it is difficult to position the fingertip, functional disposition in accordance with an actual use form of the touch input device can be made.

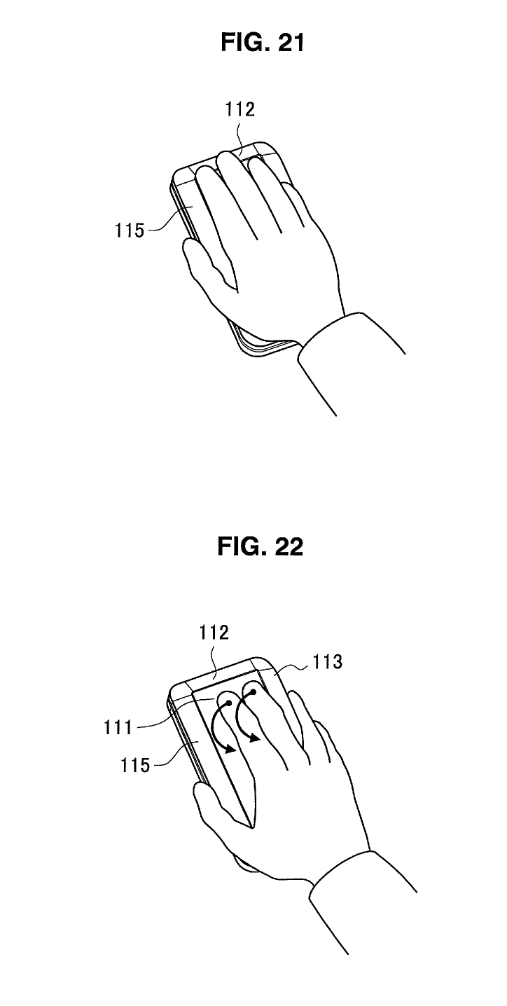

FIG. 21 is a diagram for describing Assignment Example 21 of an output value according to a touch operation on the touch input face 110a. In Assignment Example 21, the user covers the entire flat face 111 with his or her hand as a touch operation. Then, the microcontroller 136 assigns an output value for switching the computer 200 into a sleep mode. For example, when there are five or more contact points on the touch input face 110a, the entire flat face 111 is detected to be covered with the hand.

FIG. 22 is a diagram for describing Assignment Example 22 of an output value according to a touch operation on the touch input face 110a. In Assignment Example 22, the user traces the flat face 111 with two of his or her fingers in an arc shape as a touch operation. Then, the microcontroller 136 assigns an output value for rotating an object to be operated on the display screen 220.

The assignment methods (input methods) of the output values described above are realized when the microcontroller 136 executes a program recorded in a recording medium. The recording medium is, for example, a so-called memory card or the like configured as a semiconductor memory. Note that the program may be downloaded from a server via a network.

<3. Other Embodiments>

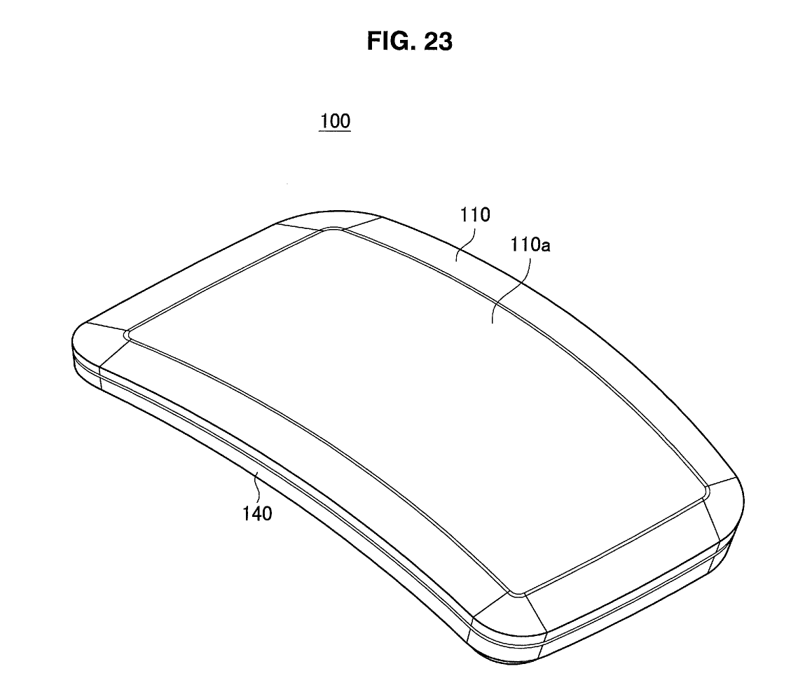

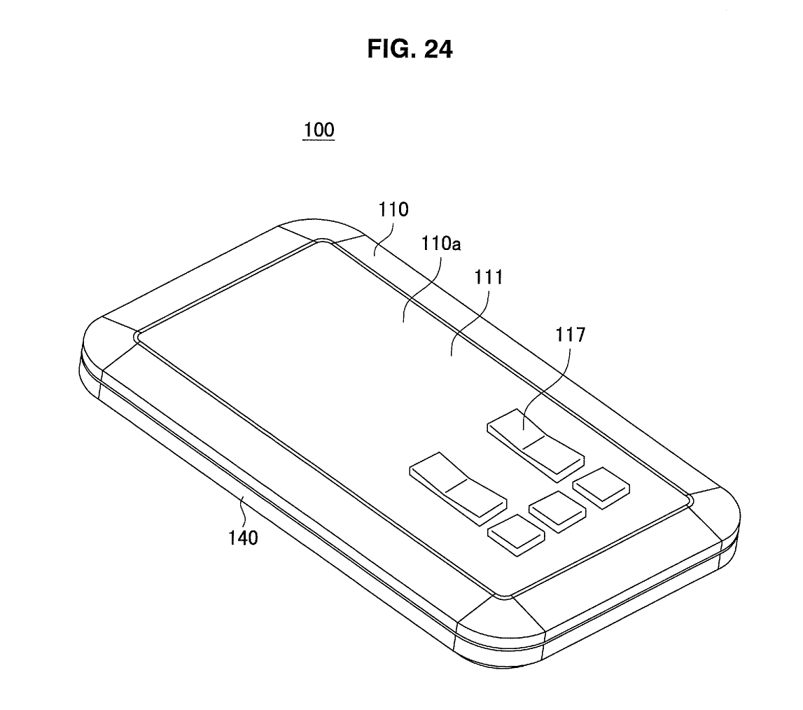

Although the touch input device 100 has been described above as having a rectangular shape as illustrated in FIG. 1, the shape is not limited thereto. For example, the touch input device 100 may have the shapes illustrated in FIGS. 23 and 24.

FIG. 23 is a perspective diagram illustrating a first modified example of an exterior configuration of the touch input device 100. The touch input device 100 according to the first modified example has a curved shape in the longitudinal direction. For this reason, the touch input face 110a of the touch input device 100 forms a curved face. Accordingly, for example, a user's hand comfortably fits on the touch input device 100 and thus operability thereof is enhanced.

FIG. 24 is a perspective diagram illustrating a second modified example of the exterior configuration of the touch input device 100. In the touch input device 100 according to the second modified example, a plurality of switches 117 that can be pressed are provided on the flat face 111. Accordingly, in addition to the inputs in the touch operations described above, inputs using the switches 117 can also be made.

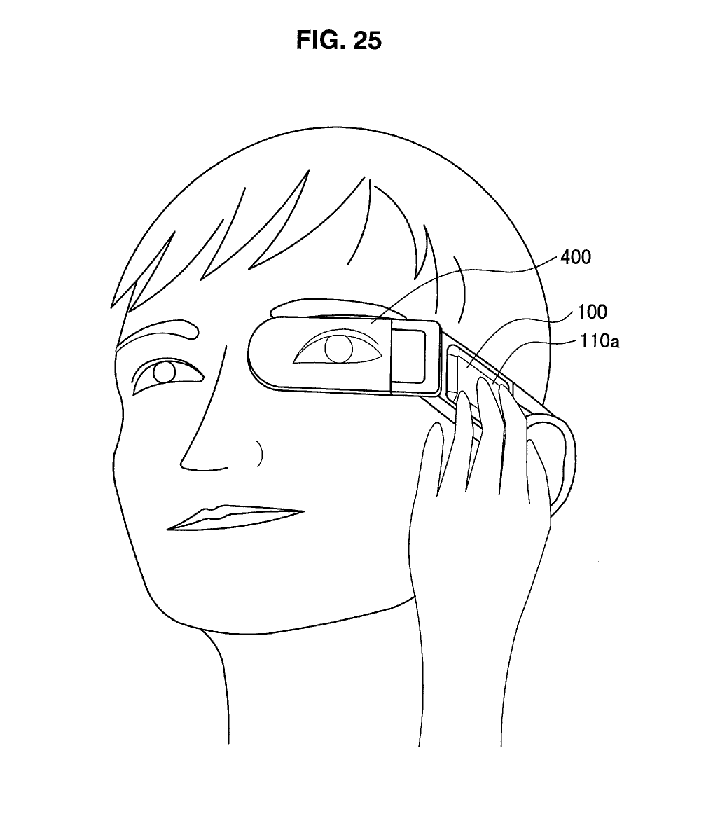

In addition, although the touch input device 100 has been described above as being used as a mouse, the usage is not limited thereto. For example, the touch input device 100 may be incorporated into a head-mount display 400 as illustrated in FIG. 25.

FIG. 25 is a diagram for describing another use form of the touch input device 100. In another embodiment, a user who wears the head-mount display 400 performs a touch operation with the touch input device 100 positioned out of a range of his or her vision while viewing the display.

<4. Conclusion>

As described above, the touch input device 100 detects operations of an operating body (finger) in the plurality of input regions on the touch input face 110a that includes the plurality of input regions (the flat face 111 and the inclined faces 112, 113, 114, and 15) having different touch feelings. In addition, the touch input device 100 assigns different output values according to the operations of the operating body in each of the input regions based on detection results of the touch detection unit 122.

In the case of the configuration described above, since the user can perceive positions on the touch input face 110a and orientations thereof by performing touch operations in the plurality of input regions having different touch feelings even when the touch input device 100 is placed out of a range of the user's vision, intended operations can be performed. Particularly, operation positions can be easily perceived even when the user does not move his or her finger.

Accordingly, touch operations can be easily and reliably executed without the user hesitating to perform a touch operation using the touch input device 100 and without erroneous inputs or lack of response contrary to an intended input. Furthermore, by assigning different output values according to operations of fingers in each of the input regions, more operations with respect to the touch input face 110a than in the related art can be assigned.

Hereinabove, although exemplary embodiments of the present disclosure have been described in detail with reference to the accompanying drawings, the technical scope of the present disclosure is not limited to the examples. It is obvious that a person who possesses general knowledge in the technical field of the present disclosure can obtain various kinds of modified examples or altered examples within the scope of the technical gist of the claims, and it is understood that such examples also belong to the technical scope of the present disclosure.

Additionally, the present technology may also be configured as below:
(1) An input device including:

an input face including a plurality of input regions having different touch feelings;

a detection unit configured to detect an operation of an operating body in the plurality of input regions; and

an assignment unit configured to assign different output values according to operations of the operating body in each of the input regions based on detection results of the detection unit.
(2) The input device according to (1), wherein the different touch feelings are touch feelings in which it is possible to perceive a position on the input face and an orientation without a movement of the operating body made by an operator.
(3) The input device according to (1) or (2), wherein the input face forms the plurality of input regions as angles of surfaces are changed.
(4) The input device according to any one of (1) to (3), wherein the input face includes a flat face positioned at a center and inclined faces formed to be inclined around the flat face.
(5) The input device according to any one of (1) to (3), wherein the input face is a curved face.
(6) The input device according to any one of (1) to (5), wherein the assignment unit assigns an output value corresponding to an operation performed on a display screen of a display device as the output value.
(7) The input device according to (6), wherein the assignment unit assigns the output value in a manner that an operation performed on the display screen corresponds to an operation in the input regions.
(8) The input device according to any one of (1) to (7), wherein the assignment unit assigns different output values according to operations of the operating body performed between the plurality of input regions.
(9) The input device according to any one of (1) to (7), wherein the assignment unit assigns different output values according to operation positions of the operating body in the input regions.
(10) The input device according to any one of (1) to (9),

wherein the operating body is a finger of an operator, and

wherein the assignment unit assigns different output values according to an operation of a plurality of fingers in the plurality of input regions.
(11) The input device according to any one of (1) to (10), wherein the assignment unit assigns an output value corresponding to at least one of operations including display of a menu on a display screen, scrolling of the display screen, switching of an application to be executed, turning of a page on the display screen, division of the display screen, enlargement and reduction of the display screen, a specific key operation, a change in volume of sound, a shift to a standby mode of the display screen, display of a search menu, and unlocking of the display screen.
(12) An input method including:

detecting an operation of an operating body in a plurality of input regions on an input face including the plurality of input regions having different touch feelings; and

assigning different output values according to operations of the operating body in each of the input regions based on detection results.
(13) A non-transitory computer-readable recording medium having a program recorded thereon, the program causing a computer to execute:

detecting an operation of an operating body in a plurality of input regions on an input face configured to include the plurality of input regions having different touch feelings; and

assigning different output values according to operations of the operating body in each of the input regions based on detection results.

What is claimed is:

1. An input device comprising:
an input face including a plurality of input regions having different touch feelings;
a detection unit configured to detect an operation of an operating body in the plurality of input regions; and
an assignment unit configured to assign different output values according to operations of the operating body in each of the input regions based on detection results of the detection unit.

2. The input device according to claim 1, wherein the different touch feelings are touch feelings in which it is possible to perceive a position on the input face and an orientation without a movement of the operating body made by an operator.

3. The input device according to claim 1, wherein the input face forms the plurality of input regions as angles of surfaces are changed.

4. The input device according to claim 1, wherein the input face includes a flat face positioned at a center and inclined faces formed to be inclined around the flat face.

5. The input device according to claim 1, wherein the input face is a curved face.

6. The input device according to claim 1, wherein the assignment unit assigns an output value corresponding to an operation performed on a display screen of a display device as the output value.

7. The input device according to claim 6, wherein the assignment unit assigns the output value in a manner that an operation performed on the display screen corresponds to an operation in the input regions.

8. The input device according to claim 1, wherein the assignment unit assigns different output values according to operations of the operating body performed between the plurality of input regions.

9. The input device according to claim 1, wherein the assignment unit assigns different output values according to operation positions of the operating body in the input regions.

10. The input device according to claim 1,
wherein the operating body is a finger of an operator, and
wherein the assignment unit assigns different output values according to an operation of a plurality of fingers in the plurality of input regions.

11. The input device according to claim 1, wherein the assignment unit assigns an output value corresponding to at least one of operations including display of a menu on a display screen, scrolling of the display screen, switching of an application to be executed, turning of a page on the display screen, division of the display screen, enlargement and reduction of the display screen, a specific key operation, a change in volume of sound, a shift to a standby mode of the display screen, display of a search menu, and unlocking of the display screen.

12. An input method comprising:
detecting an operation of an operating body in a plurality of input regions on an input face including the plurality of input regions having different touch feelings; and
assigning different output values according to operations of the operating body in each of the input regions based on detection results.

13. A non-transitory computer-readable recording medium having a program recorded thereon, the program causing a computer to execute:
detecting an operation of an operating body in a plurality of input regions on an input face configured to include the plurality of input regions having different touch feelings; and
assigning different output values according to operations of the operating body in each of the input regions based on detection results.
